(19) United States
(12) Patent Application Publication
(10) Pub. No.: US 2016/0149198 A1
(43) Pub. Date: May 26, 2016

(54) RECHARGEABLE BATTERY PACK

(71) Applicant: Samsung SDI Co., Ltd., Yongin-si (KR)

(72) Inventor: Jae-Il SEONG, Yongin-si (KR)

(21) Appl. No.: 14/940,638

(22) Filed: Nov. 13, 2015

(30) Foreign Application Priority Data
Nov. 20, 2014 (KR) 10-2014-0162256

(51) Int. Cl. H01M 2/34; H01M 2/38; H02J 7/00

(52) U.S. Cl. CPC H01M 2/34; H02J 7/0026; H02J 7/0042; H01M 2/38; H01M 2220/20; H01M 2220/30

(57) ABSTRACT

Disclosed herein is a rechargeable battery pack preventing a protection circuit module from being deformed and dented into a battery cell side even in the case in which an impact is delivered to the rechargeable battery pack from the outside. The rechargeable battery pack according to an exemplary embodiment of the present invention includes: a battery cell that is charged and discharged; a protection circuit module disposed to be spaced apart from a cap plate of the battery cell so as to electrically protect the battery cell and be electrically connected to an electrode terminal and the cap plate of the battery cell; and an interval setting unit provided between the cap plate and the protection circuit module so as to set a safety interval between the electrode terminal and the protection circuit module.

### RELATED APPLICATIONS

This application claims priority to and the benefit of Korean Patent Application No. 10-2014-0162256 filed in the Korean Intellectual Property Office on Nov. 20, 2014, the entire contents of which are incorporated herein by reference.

### BACKGROUND

1. Field

The present invention relates to a rechargeable battery pack including a protection circuit module outside a battery cell.

2. Description of the Related Art

A rechargeable battery is a battery that is repeatedly charged and discharged. A small capacity rechargeable battery may be used in a portable small electronic device such as a mobile phone, a notebook computer, and a camcorder, and a large capacity rechargeable battery may be used as a power supply for driving a motor of an electric bicycle, a scooter, an electric vehicle, a fork lift, and the like.

The rechargeable battery may be used where a plurality of battery cells are connected to each other or a single pack state, depending on a kind of device in which the rechargeable battery is used. A rechargeable battery pack often includes the battery cells, and protection circuit modules (PCMs) electrically connected to electrode terminals of the battery cells to protect the battery cells.

The protection circuit module is configured to prevent an over-charging, an over-discharging, an over-current, and a short circuit of the battery cell. The protection circuit module is electrically connected to the battery cell. Since there is a space between the protection circuit module and the battery cell of the rechargeable battery pack, the protection circuit module can be deformed and dented into the battery cell side when the rechargeable battery pack falls, which impacts the electrode terminal of the battery cell. This impact may cause cracks in the battery cell and the protection circuit module.

The above information disclosed in this Background section is only for enhancement of understanding of the background of the invention and therefore it may contain information that does not form the prior art that is already known in this country to a person of ordinary skill in the art.

### SUMMARY OF CERTAIN INVENTIVE ASPECTS

The present invention has been made in an effort to provide a rechargeable battery pack having advantages of preventing a protection circuit module from being deformed and dented into a battery cell side even in the case in which an impact is delivered to the rechargeable battery pack from the outside.

An exemplary embodiment of the present invention provides a rechargeable battery pack including: a battery cell that is charged and discharged; a protection circuit module disposed to be spaced apart from a cap plate of the battery cell so as to electrically protect the battery cell and electrically be connected to an electrode terminal and the cap plate of the battery cell; and an interval setting unit provided between the cap plate and the protection circuit module so as to set a safety interval between the electrode terminal and the protection circuit module.

A pair of the interval setting units may be provided to both side of the electrode terminal.

One of the interval setting units may be provided between the electrode terminal and an electrolyte injection hole.

The rechargeable battery pack may further include a protection member electrically connecting the electrode terminal and the protection circuit module, wherein the protection member may include a first connection unit connected to the electrode terminal, a protection element connected to the first connection unit, and a second connection unit connected to the protection element so as to be connected to the protection circuit module, and wherein the first connection unit may be formed so as to bypass the interval setting unit of one side.

The interval setting unit may form an interval between the cap plate and the protection circuit module so as to be larger than the safety interval.

The interval setting unit may protrude from the cap plate toward the protection circuit module.

In a plane direction of the cap plate, a set area of the interval setting unit may be formed to be smaller than a set area of the electrode terminal.

The interval setting unit may protrude from the protection circuit module toward the cap plate.

The interval setting unit may be interposed between the cap plate and the protection circuit module.

The interval setting unit may be coupled to at least one side of the cap plate and the protection circuit module.

The cap plate may protrude toward the interval setting unit so as to be coupled to the interval setting unit, and the interval setting unit may protrude toward the protection circuit module so as to be coupled to the protection circuit module.

According to an embodiment of the present invention, since the interval setting unit is provided between the cap plate of the battery cell and the protection circuit module, the protection circuit module may be supported. Therefore, even in the case in which the external impact is delivered to the rechargeable battery pack, since the protection circuit module is supported by the interval setting unit, the protection circuit module may not be deformed and dented into the battery cell side. Since the protection circuit module is not deformed and dented into the battery cell side or is minimally deformed and dented into the battery cell side, the electrode terminal of the battery cell may safe from the external impact.

### BRIEF DESCRIPTION OF THE DRAWINGS

FIG. 1 is an exploded perspective view of a rechargeable battery pack according to a first exemplary embodiment of the present invention.

FIG. 2 is a plan view of a state in which a safety member is connected to a cap plate in FIG. 1.

FIG. 3 is a cross-sectional view taken along the line III-III of FIG. 1.

FIG. 4 is a cross-sectional view of a rechargeable battery pack according to a second exemplary embodiment of the present invention.

FIG. 5 is a cross-sectional view of a rechargeable battery pack according to a third exemplary embodiment of the present invention.

### DETAILED DESCRIPTION OF CERTAIN INVENTIVE EMBODIMENTS

Hereinafter, in the following detailed description, the present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification.

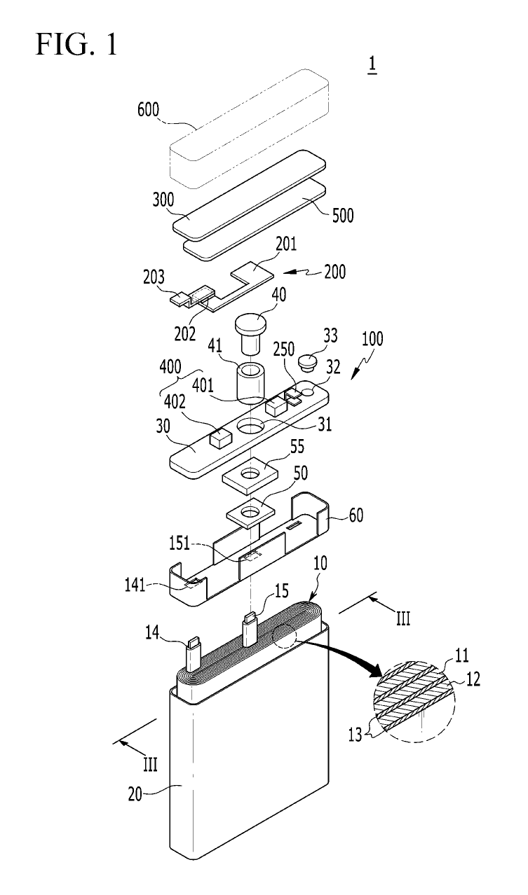

FIG. 1 is an exploded perspective view of a rechargeable battery pack according to a first exemplary embodiment of the present invention. Referring to FIG. 1, a rechargeable battery pack 1 according to a first exemplary embodiment includes a battery cell 100 that is charged and discharged, a protection circuit module 300 electrically connected to an electrode terminal 40 of the battery cell 100 and a cap plate 30, and an interval setting unit 400 provided between the battery cell 100 and the protection circuit module 300.

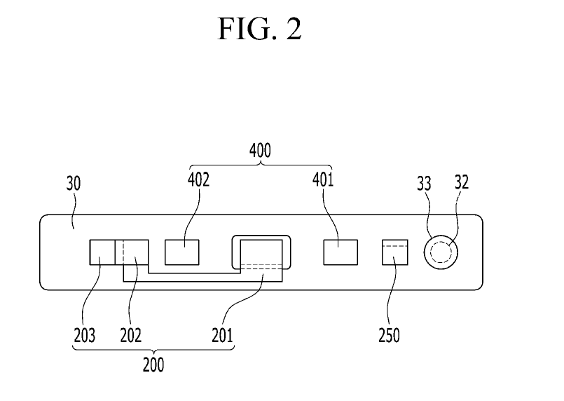

FIG. 2 is a plan view of a state in which a safety member is connected to a cap plate in FIG. 1. Referring FIGS. 1 and 2, the battery cell 100 and the protection circuit module 300 are electrically connected to each other, having a protection member 200 and a connection member 250 interposed therebetween.

The protection member 200 is formed to electrically protect the battery cell 100, disposed at the outer side of the cap plate 30 to be spaced apart from the cap plate 30, and electrically connected to the electrode terminal 40 and the protection circuit module 300.

By way of example, the protection member 200 includes a first connection unit 201 connected to the electrode terminal 40, a protection element 202 connected to the first connection unit 201, and a second connection unit 203 connected to the protection element 202 so as to be connected to the protection circuit module 300.

When a temperature of the battery cell 100 exceeds a set value at the time of charging and discharging the battery cell 100, the protection member 200 is configured to allow the electrical connection between the battery cell 100 and the protection circuit module 300 to be blocked. The protection element 202 may be a resistor element having a positive temperature coefficient.

Since the interval setting unit 400 is provided, the first connection unit 201 of the protection member 200 is formed to bypass the interval setting unit 400. That is, the first connection unit 201 bypasses the interval setting unit 400 so as to be connected to the electrode terminal 40, and the protection element 202 and the electrode terminal 40 are disposed having the interval setting unit 400 therebetween.

Referring again to FIG. 1, the protection circuit module 300 is disposed at the outer side of the cap plate 30 to be spaced apart from the cap plate 30 of the battery cell 100, electrically connected to the protection member 200, and electrically connected to the cap plate 30 by the connection member 250. Although not shown, the protection circuit module 300 further includes a separate external terminal so as to be electrically connected to an electric device, thereby enabling the battery cell 100 to be charged and discharged.

By way of example, the protection circuit module 300 comprises an electrical circuit and has a variety of elements mounted thereon so as to electrically protect the battery cell 100 by preventing an over-charging, an over-discharging, an over-current, and a short circuit of the battery cell 100.

The interval setting unit 400 sets a safety interval G1 between the electrode terminal 40 and the protection circuit module 300 to thereby safely support the protection circuit module 300 even in the case in which external impact due to falling, vibration, and the like is delivered to the protection circuit module 300, thereby keeping the safety interval G1.

That is, since the interval setting unit 400 prevents or at least inhibits the protection circuit module 300 from being deformed and dented into the battery cell 100 side by the external impact or allows the protection circuit module 300 to be less deformed and dented into the battery cell 100 side, it may safely keep the electrode terminal 40 from the external impact.

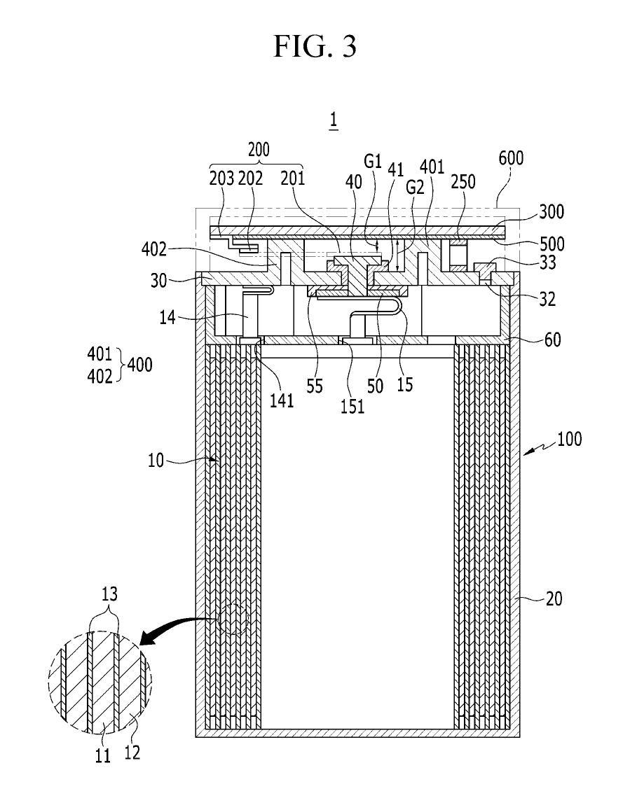

FIG. 3 is a cross-sectional view taken along the line III-III of FIG. 1. Referring to FIG. 3, the battery cell 100 includes an electrode assembly 10 charging and discharging a current, a case 20 accommodating the electrode assembly 10 together with an electrolyte, a cap plate 30 sealing an opening of the case 20, and an electrode terminal 40 installed in a terminal hole 31 of the cap plate 30 so as to be electrically connected to the electrode assembly 10.

In addition, the battery cell 100 further includes a terminal plate 50 electrically connecting the electrode terminal 40 to the electrode assembly 10, and an insulating case 60 installed between the cap plate 30 and the electrode assembly 10.

The electrode assembly 10 has a shape corresponding to an inner space of the case 20 so as to be inserted into the case 20. The electrode assembly 10 is formed to be wounded in a jelly role form by stacking a cathode 11 and an anode 12 on both surfaces thereof, having a separator 13, which is an electrical insulating material, therebetween. The electrode assembly 10 includes a cathode lead tap 14 connected to the cathode 11 and an anode lead tap 15 connected to the anode 12.

The cathode lead tap 14 is connected to a lower surface of the cap plate 30 by welding, and the case 20 is electrically connected to the cathode 11 of the electrode assembly 10 through the cap plate 30, so as to be operated as a cathode terminal.

The anode lead tap 15 is connected to a lower surface of the terminal plate 50 connected to one end of the electrode terminal 40, and the electrode terminal 40 provided in the terminal hole 31 of the cap plate 30 is electrically connected to the anode 12 of the electrode assembly 10, so as to be operated as an anode terminal.

Although not shown, the anode lead tap is connected to the cap plate so that the case may operate as the anode terminal, and the cathode lead tap is connected to the electrode terminal so that the electrode terminal may also operate as the cathode terminal.

By way of example, the electrode terminal 40 is inserted into the terminal hole 31 of the cap plate 30 by interposing an insulating gasket 41 and is riveted. In this case, the insulating gasket 41 electrically insulates the terminal hole 31 and the electrode terminal 40 and forms a sealing structure between the terminal hole 31 and the electrode terminal 40.

The terminal plate 50 is riveted to the electrode terminal 40 by interposing the insulating plate 55 so as to be electrically connected to the electrode terminal 40. That is, the insulating plate 55 electrically insulates the cap plate 30 and the terminal plate 50 and further forms a sealing structure between the cap plate 30 and the terminal plate 50.

The case 20 enables the electrode assembly 10 and the insulating case 60 to be inserted through the opening provided in a top thereof. In addition, the case 20 accommodates the electrode assembly 10 together with the cap plate 30 coupled to the opening and is formed as a conductor so as to be able to serve as the electrode terminal. For example, the case 20 may be formed of aluminum or an aluminum alloy.

The insulating case 60 is installed between the electrode assembly 10 and the terminal plate 50 in the case 20 so as to electrically insulate the electrode assembly 10 and the terminal plate 50. That is, the insulating case 60 electrically insulates the cathode 11 of the electrode assembly 10 and the terminal plate 50 having anodic property from each other.

In addition, the insulating case 60 includes tap holes 141 and 151 that penetrate through the cathode lead tap 14 and the anode lead tap 15. Therefore, the cathode lead tap 14 may penetrate through the tap hole 141 so as to be connected to the cap plate 30, and the anode lead tap 15 may penetrate through the tap hole 151 so as to be connected to the terminal plate 50.

The cap plate 30 further includes an electrolyte injection hole 32. The electrolyte injection hole 32 allows an electrolyte to be injected into the case 20 after the cap plate 30 is coupled and welded to the case 20. After the electrolyte is injected, the electrolyte injection hole 32 is sealed by a sealing closure 33.

Referring to FIGS. 1 and 3, the rechargeable battery pack 1 further includes an insulating tape 500 and a top case 600. The insulating tape 500 is disposed on inner sides of the protection circuit module 300 so as to prevent or inhibit an unnecessary short circuit between the protection member 200 and the protection circuit module 300 and a short circuit between the cap plate 30 and the protection circuit module 300.

The top case 600 is formed of an insulating material, covers the protection circuit module 300 so as to protect and insulate an outer portion of the protection circuit module 300, and is mounted on the battery cell 100. Although not shown, the top case 600 may be mounted on the cap plate 30 of the battery cell 100 by a set screw.

Referring to again FIGS. 1 to 3, interval setting units 400, 401, and 402 may be provided on both sides of the electrode terminal 40 as a first interval setting unit 401 and at least one second interval setting units 402. That is, the first interval setting unit 401 is provided between the electrode terminal 40 and the electrolyte injection hole 32.

The first and second interval setting units 401 and 402 set an interval G2 between the cap plate 30 and the protection circuit module 300. That is, the interval G2 by the first and second interval setting units 401 and 402 is formed to be larger than the safety interval G1.

By way of example, the first and second interval setting units 401 and 402 protrude from the cap plate 30 toward the protection circuit module 300 as much as the interval G2. In a plane direction of the cap plate 30, set areas of the first and second interval setting units 401 and 402 are formed to be smaller than a set area of the electrode terminal 40. In one non-limiting implementation, the settling units 401 and 402 may be integrally formed with cap plate 30.

Since the first and second interval setting units 401 and 402 support the protection circuit module 300 with the interval G2 at both sides of the electrode terminal 40, the protection circuit module 300 is supported by the first and second interval setting units 401 and 402 by interposing the insulating tape 500 even in the case in which external impact acts on the protection circuit module 300.

Therefore, the electrode terminal 40 may maintain a state in which it is spaced apart from the protection circuit module 300 by the safety interval G1. That is, even in the case in which the external impact acts on the protection circuit module 300, the protection circuit module 300 may maintain the safety interval G1 or an interval which is narrower than the safety interval G1 with the electrode terminal 40 by the first and second interval setting units 401 and 402.

Since the protection circuit module 300 is less likely to be deformed and dented into the electrode terminal 40 or is minimally deformed and dented into the electrode terminal 40 despite of the external impact, the electrode terminal 40 may be more safe from the external impact. In addition, in the case in which the insulating tape 500 is formed of a buffering material, the first and second interval setting units 401 and 402 may also further alleviate the external impact delivered from the protection circuit module 300.

Hereinafter, various exemplary embodiments of the present invention will be described. A description for the same configurations as those of a first exemplary embodiment and the above described exemplary embodiment will be omitted, and configurations different from those of the first exemplary embodiment and the above described exemplary embodiment will be described.

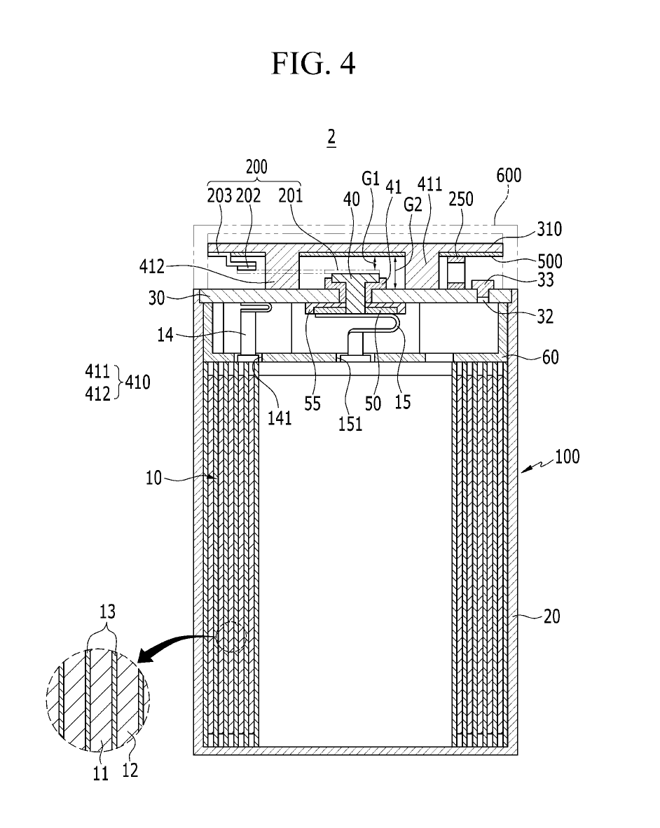

FIG. 4 is a cross-sectional view of a rechargeable battery pack according to a second exemplary embodiment of the present invention. Referring to FIG. 4, an interval setting unit 410 in a rechargeable battery pack 2 according to the second exemplary embodiment protrudes from a protection circuit module 310 toward a cap plate 230. The interval setting unit 410 is provided to both sides of an electrode terminal 40 as a pair of first interval setting unit 411 and second interval setting unit 412.

The first and second interval setting units 411 and 412 support the cap plate 230 at both sides of the electrode terminal 40 so as to set the interval G2 between the protection circuit module 310 and the cap plate 230. Therefore, even in the case in which the external impact acts on the protection circuit module 310, the protection circuit module 310 is not deformed and dented into the cap plate 230 side or is minimally deformed and dented into the cap plate 230 side.

That is, the protection circuit module 310 may maintain the safety interval G1 or an interval which is narrower than the safety interval G1 with the electrode terminal 40 by the first and second interval setting units 411 and 412. Since the protection circuit module 310 is less likely to be deformed and dented into the electrode terminal 40 or is minimally deformed and dented into the electrode terminal 40 despite of the external impact, the electrode terminal 40 may be safer from the external impact. In one non-limited implementation, the settling units 411 and 412 may be integrally formed with the printed circuit module.

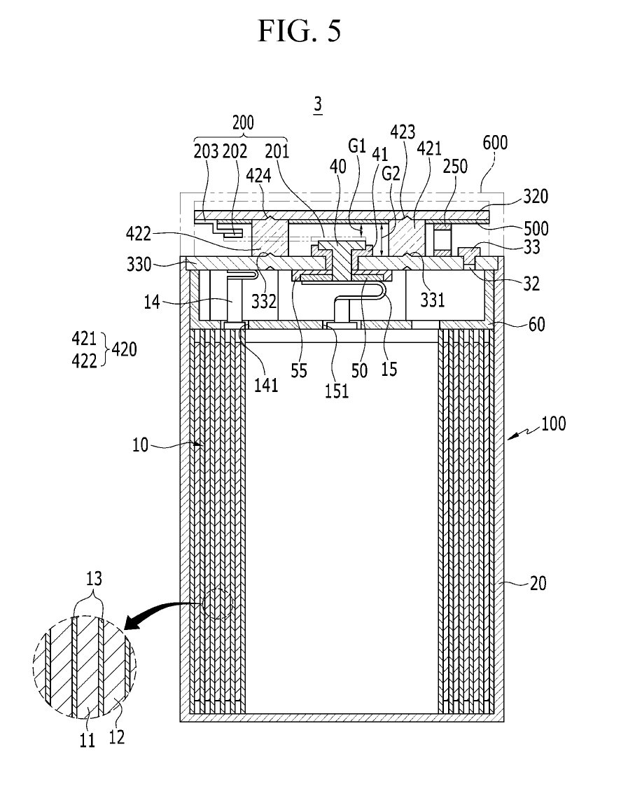

FIG. 5 is a cross-sectional view of a rechargeable battery pack according to a third exemplary embodiment of the present invention. Referring to FIG. 5, an interval setting unit 420 in a rechargeable battery pack 3 according to the third exemplary embodiment is separately manufactured so as to be interposed between a cap plate 330 and a protection circuit module 320.

The interval setting unit 420 is provided to both sides of the electrode terminal 40 as a pair of first interval setting unit 421 and second interval setting unit 422. The first and second interval setting units 421 and 422 are coupled to at least one side of the cap plate 330 and the protection circuit module 320.

By way of example, the cap plate 330 is coupled to the first and second interval setting units 421 and 422 by protrusions 331 and 332 that protrude toward the first and second interval setting units 421 and 422, and the first and second interval setting units 421 and 422 are coupled to the protection circuit module 320 by protrusions 423 and 424 that protrude toward the protection circuit module 320.

The protrusions 331 and 332 fix positions of the first and second interval setting units 421 and 422 on the cap plate 330 and the protrusions 423 and 424 fix positions of the first and second interval setting units 421 and 422 below the protection circuit module 320.

The first and second interval setting units 421 and 422 support between the cap plate 330 and the protection circuit module 320 at both sides of the electrode terminal 40 so as to set the interval G2 between the protection circuit module 320 and the cap plate 330. Therefore, even in the case in which the external impact acts on the protection circuit module 320, the protection circuit module 320 is not deformed and dented into the cap plate 230 side or is minimally deformed and dented into the cap plate 230 side.

That is, the protection circuit module 320 may maintain the safety interval G1 or an interval which is narrower than the safety interval G1 with the electrode terminal 40 by the first and second interval setting units 421 and 422. Since the protection circuit module 320 is less likely to be deformed and dented into the electrode terminal 40 or is minimally deformed and dented into the electrode terminal 40 despite of the external impact, the electrode terminal 40 may be safer from the external impact.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A rechargeable battery pack, comprising:
a battery cell that is charged and discharged;
a protection circuit module disposed to be spaced apart from a cap plate of the battery cell so as to electrically protect the battery cell and electrically connected to an electrode terminal and the cap plate of the battery cell; and
an interval setting unit provided between the cap plate and the protection circuit module so as to set a safety interval between the electrode terminal and the protection circuit module.

2. The rechargeable battery pack of claim 1, wherein a pair of the interval setting units is provided to both side of the electrode terminal.

3. The rechargeable battery pack of claim 2, wherein one of the interval setting units is provided between the electrode terminal and an electrolyte injection hole.

4. The rechargeable battery pack of claim 2, further comprising:
a protection member electrically connecting the electrode terminal and the protection circuit module,
wherein the protection member includes
a first connection unit connected to the electrode terminal,
a protection element connected to the first connection unit, and
a second connection unit connected to the protection element so as to be connected to the protection circuit module,
wherein the first connection units formed so as to bypass the interval setting unit of one side.

5. The rechargeable battery pack of claim 1, wherein the interval setting unit forms an interval between the cap plate and the protection circuit module so as to be larger than the safety interval.

6. The rechargeable battery pack of claim 1, wherein the interval setting unit protrudes from the cap plate toward the protection circuit module.

7. The rechargeable battery pack of claim 1, wherein in a plane direction of the cap plate, a set area of the interval setting unit is formed to be smaller than a set area of the electrode terminal.

8. The rechargeable battery pack of claim 1, wherein the interval setting unit protrudes from the protection circuit module toward the cap plate.

9. The rechargeable battery pack of claim 1, wherein the interval setting unit is interposed between the cap plate and the protection circuit module.

10. The rechargeable battery pack of claim 9, wherein the interval setting unit is coupled to at least one side of the cap plate and the protection circuit module.

11. The rechargeable battery pack of claim 9, wherein the cap plate protrudes toward the interval setting unit so as to be coupled to the interval setting unit, and the interval setting unit protrudes toward the protection circuit module so as to be coupled to the protection circuit module.

12. A rechargeable battery pack comprising: a battery cell that has a first surface and at least one electrode terminal positioned on the first surface;
a protection circuit module that is positioned so as to be aligned with and spaced apart from the first surface of the battery cell wherein the protection circuit module is electrically connected to the at least one electrode terminal of the battery cell via at least one conductive connectors that extend between the first surface of the battery cell and the protection circuit module; and
a plurality of support members, that are separate from the conductive connectors, that extend between the first surface and the protection circuit module so as to space the protection circuit module a first distance from the at least one electrode terminal.

13. The battery pack of claim 12, wherein the at least one electrode terminal comprises a first electrode terminal that is positioned at a center location of the first surface and wherein the plurality of support members comprise a first and second support member that are respectively positioned on a first and a second sides of the electrode terminal.

14. The battery pack of claim 13, wherein the at least one conductive connector is coupled to the first electrode terminal and extends towards the protection circuit module in the direction of the first side of the electrode terminal and wherein the at least one conductive connector is contoured to be spaced from the first support member.

15. The battery pack of claim 14, wherein the first support member has a first width and the first surface has a second width greater than the first width and wherein the at least one conductive connector is positioned adjacent the first surface and has a cut-out that receives the first support member.

16. The battery pack of claim 12, wherein the first and second support members are integrally formed with the first surface of the battery cell.

17. The battery pack of claim 12, wherein the first and second support members are integrally formed with a first surface of the protection circuit module.

18. The battery pack of claim 12, wherein the first and second support members have connection elements that engage with connection elements on the first surface of the battery cell and the protection circuit module.

19. The battery pack of claim 18, wherein the connection element on the first surface comprises a protrusion that engages with a groove at a first end of the first and second support elements and wherein a second end of the first and second elements comprise protrusions that engage with grooves that are formed on the protection circuit module.

20. The battery pack of claim 12, wherein the battery cell includes an electrolyte injection hole formed in the first surface of the battery cell and wherein the plurality of support members include a support member that is interposed between the first electrode terminal and the electrolyte injection hole.
